(19) United States
(12) Patent Application Publication
(10) Pub. No.: US 2026/0073351 A1
(43) Pub. Date: Mar. 12, 2026

(54) SYSTEMS AND METHODS FOR GENERATING A TRAILER LOADING PLAN

(71) Applicant: Torc Robotics, Inc., Blacksburg, VA (US)

(72) Inventors: Akshay Pai Raikar, Austin, TX (US); William Gray Davis, Austin, TX (US); Nicholas Atanasov, Austin, TX (US); Armenio Jose Rivero, Austin, TX (US); Pablo Smith, Spicewood, TX (US); Christopher Harrison, Austin, TX (US)

(21) Appl. No.: 18/829,805

(22) Filed: Sep. 10, 2024

(51) Int. Cl. G06Q 10/087

(52) U.S. Cl. CPC G06Q 10/087

(57) ABSTRACT

A method of generating a trailer loading plan is provided. The method involves receiving information for each of a plurality of packages that includes at least dimensions and a mass of each package, and determining trailer information that includes at least dimensions of a trailer's internal volume. The method further involves determining a position for each of the plurality of packages within the internal volume based at least in part on the information for each of the plurality of packages, the dimensions of the internal volume, and a resulting center of gravity of the trailer and the plurality of packages, e.g., a center of gravity of the trailer when loaded with the plurality of packages in their respective positions, and generating a trailer loading plan that includes the position for each of the plurality of packages within the internal volume. A system for performing the method is also provided.

### TECHNICAL FIELD

The present disclosure relates generally to the field of transportation logistics. More specifically, the present disclosure relates to systems and methods for generating a trailer loading plan that accounts for various safety factors and information for a plurality of packages.

### BACKGROUND

In the world of transportation logistics, one of the crucial tasks is determining how freight, including packages of varying shapes, sizes, and weights, is to be transported, and ensuring that the freight is transported safely and efficiently. Included in this task, is the development of a plan for loading packages into the transportation vehicle, e.g., the trailer of a commercial truck, which can directly impact shipping time and costs. However, this task is often complex and time consuming due to the multitude of variables to be considered. For example, packages can come in all different shapes, sizes, and weights, and have different delivery locations, while different vehicles and trailers can have different configurations and storage dimensions.

It is also critical that the resulting vehicle and trailer, when fully loaded with freight, is safe for travel and meets all regulations. Accordingly, the safety of the vehicle, trailer, and freight should also be considered when developing a loading plan.

Accordingly, there exists a need for systems and methods for generating trailer loading plans that address the foregoing and other issues.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

The present disclosure relates to systems and methods for generating a trailer loading plan.

In accordance with aspects of the present disclosure, a method of generating a trailer loading plan is provided. The method involves receiving information for each of a plurality of packages that includes at least dimensions of each package and a mass of each package. The method further involves determining trailer information that includes at least dimensions of an internal volume of a trailer. The method involves determining a position for each of the plurality of packages within the internal volume of the trailer based at least in part on the information for each of the plurality of packages, the dimensions of the internal volume of the trailer, and a resulting center of gravity of the trailer and the plurality of packages, e.g., a center of gravity of the trailer when it is loaded with the plurality of packages in their respective positions. The method additionally involves generating a trailer loading plan that includes the position for each of the plurality of packages within the internal volume of the trailer.

In some aspects, determining a position for each of the plurality of packages can involve comparing a height of the resulting center of gravity of the trailer and the plurality of packages to a maximum center of gravity height, and confirming that the height of the resulting center of gravity of the trailer and the plurality of packages is less than the maximum center of gravity height prior to generating the trailer loading plan. In such aspects, the maximum center of gravity height can be based on a travel route for the trailer.

In some other aspects, determining a position for each of the plurality of packages can involve minimizing a height of the resulting center of gravity of the trailer and the plurality of packages.

In still other aspects, the trailer information can include a maximum weight per axle, and the maximum weight per axle can be considered in determining the position for each of the plurality of packages within the internal volume of the trailer.

In some aspects, the position for each of the plurality of packages can be determined so as to maximize the amount of packages positioned within the internal volume of the trailer.

In other aspects, receiving information for each of the plurality of packages can involve scanning indicia associated with each of the plurality of packages, inputting the information for each of the plurality of packages using a user device, and/or detecting the information for each of the plurality of packages using a detection system.

In some other aspects, the method can include receiving a list of the plurality of packages to be loaded in the trailer. In such aspects, the list can include the information for each of the plurality of packages.

In still other aspects, the information for each of the plurality of packages can include a delivery location for the respective package, and the position for each of the plurality of packages within the internal volume of the trailer can be determined based at least in part on the delivery location for the respective package.

In accordance with aspects of the present disclosure, a system for generating a trailer loading plan is provided. The system includes a memory and a processor in communication with the memory. The processor receives information for each of a plurality of packages that includes at least dimensions of each package and a mass of each package. The processor also determines trailer information that includes at least dimensions of an internal volume of the trailer. The processor also determines a position for each of the plurality of packages within the internal volume of the trailer based at least in part on the information for each of the plurality of packages, the dimensions of the internal volume of the trailer, and a resulting center of gravity of the trailer and the plurality of packages, e.g., a center of gravity of the trailer when it is loaded with the plurality of packages in their respective positions. The processor additionally generates a trailer loading plan that includes the position for each of the plurality of packages within the internal volume of the trailer.

In some aspects, the processor, when determining a position for each of the plurality of packages within the internal volume of the trailer, can compare a height of the resulting center of gravity of the trailer and the plurality of packages to a maximum center of gravity height and confirm that the height of the resulting center of gravity of the trailer and the plurality of packages is less than the maximum center of gravity height prior to generating the trailer loading plan. In such aspects, the maximum center of gravity height can be based on a travel route for the trailer.

In other aspects, the processor, when determining a position for each of the plurality of packages within the internal volume of the trailer, can minimize a height of the resulting center of gravity of the trailer and the plurality of packages.

In some other aspects, the trailer information can include a maximum weight per axle, and the processor can consider the maximum weight per axle when determining the position for each of the plurality of packages within the internal volume of the trailer.

In still other aspects, the processor can determine the position for each of the plurality of packages within the internal volume of the trailer so as to maximize the amount of packages positioned within the internal volume of the trailer.

In other aspects, the processor can receive the information for each of the plurality of packages from: (i) a scanning device that is configured to scan indicia associated with each of the plurality of packages and obtain the information based on the indicia, (ii) a user input device that is configured to receive the information for each of the plurality of packages as an input by a user, and/or (iii) a detection system that is configured to detect the information for each of the plurality of packages.

In some other aspects, the processor can receive a list of the plurality of packages to be loaded in the trailer. In such aspects, the list can include the information for each of the plurality of packages.

In other aspects, the information for each of the plurality of packages can include a delivery location for the respective package, and the position for each of the plurality of packages within the internal volume of the trailer can be determined by the processor based at least in part on the respective delivery location.

Other features will become apparent from the following detailed description considered in conjunction with the accompanying drawings. It is to be understood, however, that the drawings are designed as an illustration only and not as a definition of the limits of the disclosure.

### BRIEF DESCRIPTION OF THE DRAWINGS

The foregoing features of the present disclosure will be apparent from the following Detailed Description, taken in connection with the accompanying drawings, in which:

FIG. 1 is a perspective view of a vehicle of the present disclosure;

FIG. 2 is a perspective view of the vehicle of FIG. 1 with a trailer attached thereto;

FIG. 3 is a side view of the vehicle with attached trailer of FIG. 2;

FIG. 4 is a schematic diagram of an exemplary internal volume of the trailer of the present disclosure;

FIG. 5 is a diagram showing a general overview of an exemplary transportation and distribution system of the present disclosure;

FIG. 6 is a perspective view of an exemplary package of the present disclosure;

FIG. 7 is a schematic diagram of the exemplary internal volume of FIG. 4 showing a plurality of packages loaded therein;

FIG. 8 is a side view of the vehicle and trailer of FIGS. 2 and 3 illustrating an exemplary center of gravity of the trailer and exemplary axle loads when fully loaded with cargo;

FIG. 9 is a rear view of the vehicle and loaded trailer of FIG. 8 illustrating the exemplary center of gravity of the trailer and exemplary wheel loads; and

FIG. 10 is a flowchart illustrating exemplary operations performed for generating a trailer loading plan according to the present disclosure.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

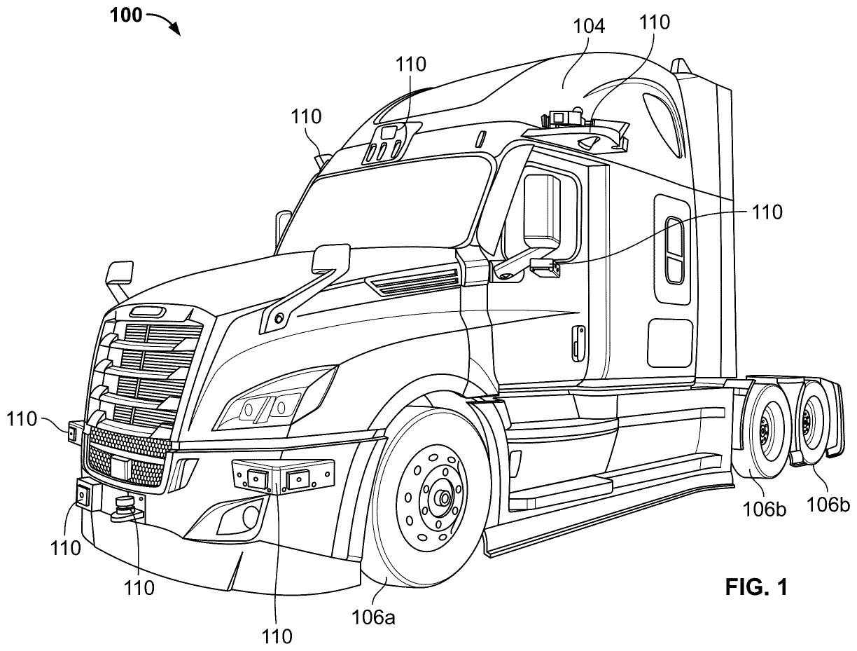

The present disclosure relates to systems and methods for generating a trailer loading plan that accounts for various safety factors and information pertaining to a plurality of packages, as described in detail below in connection with FIGS. 1-10.

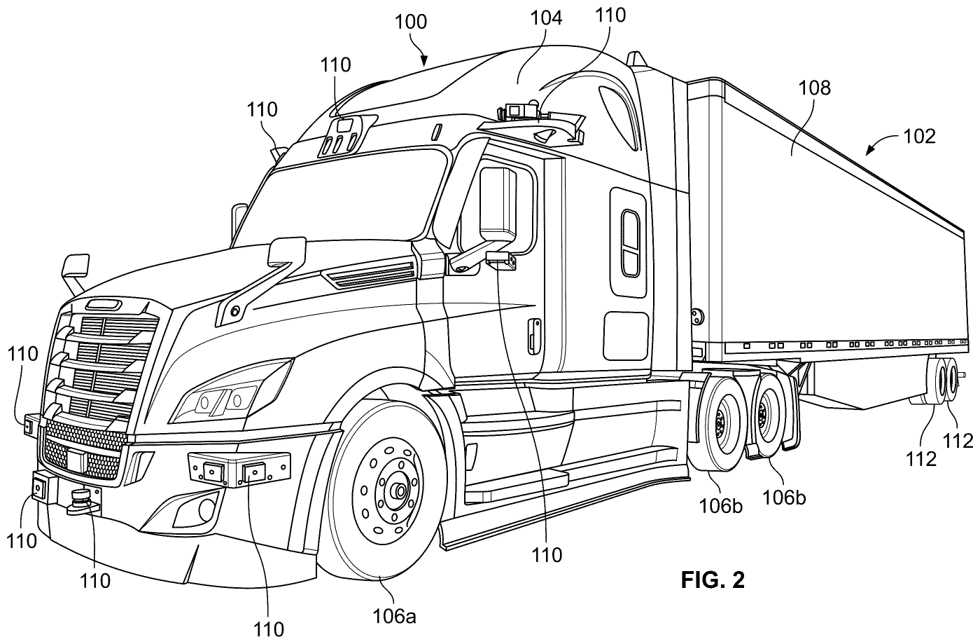

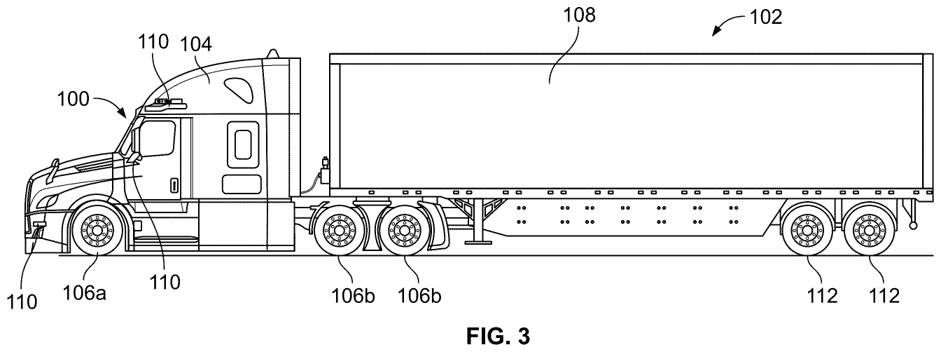

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104. The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releaseably attached. The trailer 102 can include a storage container 108 and a plurality of rear wheels 112 that support the storage container 108. It should be understood that in some embodiments the vehicle 100 and the trailer 102 can be a permanently attached as a single unit.

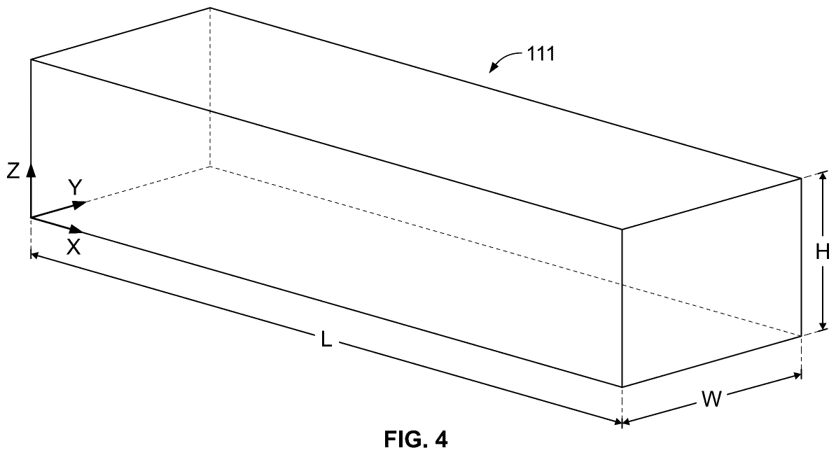

The storage container 108 of the trailer 102 defines an internal volume 111, an exemplary version of which is shown in FIG. 4, that is configured to receive and store a plurality of packages, e.g., cargo, therein for delivery. The internal volume 111 can have a length, width, and height associated therewith, and can have different shapes and sizes from one trailer 102 to another. That is, different trailers 102 can have different sized and shaped internal volumes 111 in which packages can be stored. The vehicle 100 is designed to connect with the trailer 102 and haul the trailer 102, including the plurality of packages stored therein, from one or more first locations, e.g., warehouses, distribution centers, hubs, businesses, etc., to one or more second locations, e.g., warehouses, distribution centers, businesses, hubs, residential buildings, etc., for delivery.

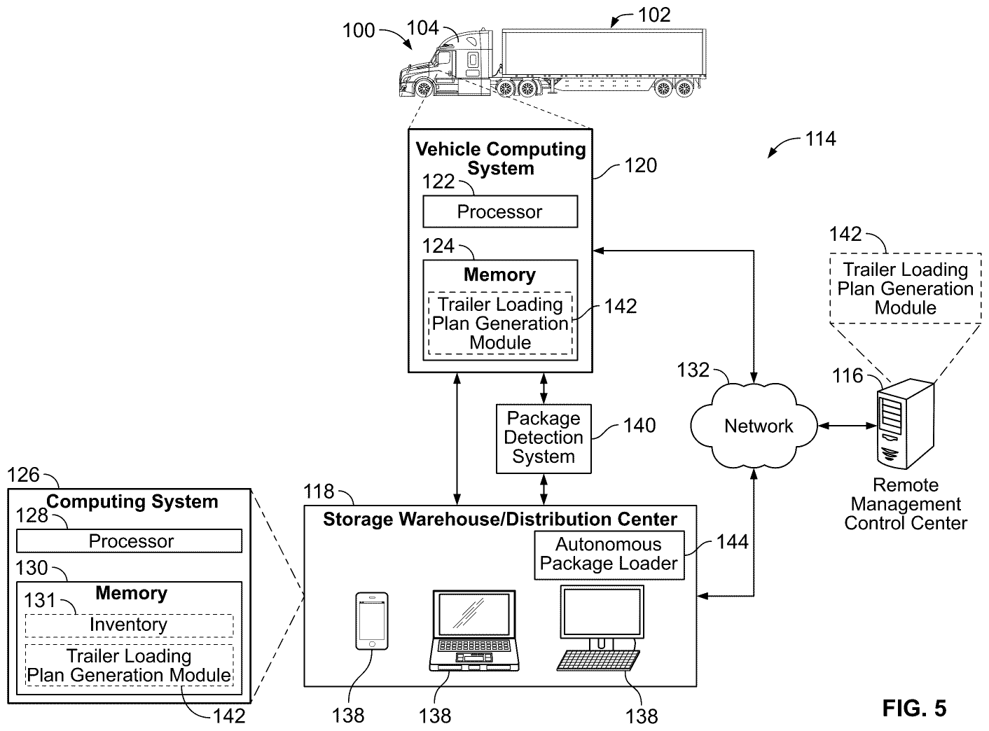

FIG. 5 is a diagram showing a general overview of an exemplary transportation and distribution system 114. The transportation and distribution system 114 includes the vehicle 100 and trailer 102, a remote management control center 116, and a storage warehouse/distribution center 118. In addition to those components discussed in connection with FIGS. 1-3, the vehicle 100 can also include a vehicle computing system 120 having a processor 122 and a memory 124. Similarly, the storage warehouse/distribution center 118 includes a computing system 126 having a processor 128 and a memory 130. The vehicle computing system 120, the remote management control center 116, and the storage warehouse/distribution center computing system 126 can be configured to communicate over a network 132, which can be a wide-area network (WAN) such as the Internet. Additionally, the vehicle computing system 120 and the storage warehouse/distribution center computing system 126 can be in direct communication over a local-area network (LAN) or a personal-area network (PAN) when the vehicle 100 is at the storage warehouse/distribution center 118 and the computing systems 120, 126 are in sufficiently close proximity. For example, the vehicle computing system 120 and the storage warehouse/distribution center computing system 126 can communicate via a serial communication protocol, such as RS-485, RS-232, USB, etc., or a wireless communication protocol, such as Bluetooth (BLE), RF, etc.

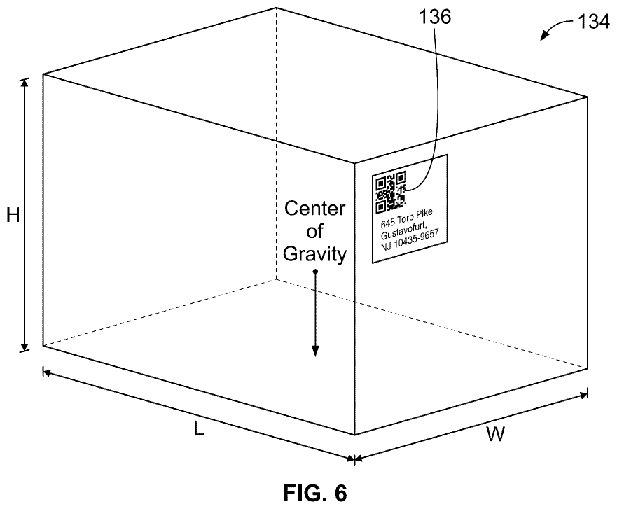

The storage warehouse/distribution center 118 contains a plurality of packages, such as package 134 illustrated in FIG. 6, that are arranged for shipment via the vehicle 100 and trailer 102. A continually updating inventory 131 of the packages 134 stored at the storage warehouse/distribution center 118 can be stored in the memory 130 of the storage warehouse/distribution center computing system 126. The inventory 131 can additionally include information pertaining to each of the packages 134, such as, but not limited to, identification information, delivery location, dimensions (e.g., height, width, length, circumference, diameter, etc., including all dimensions of regular and irregular shapes), shape, mass/weight, center of mass/gravity, fragile designation, stacking limitations (e.g., whether other packages can be stacked on top of the package), etc. The inventory 131 can be initially built and continuously updated by a user at the storage warehouse/distribution center 118 using one or more devices 138, including, but not limited to, a smartphone, a tablet, a laptop computer, a desktop computer, etc. In particular, the one or more devices 138 can include a user-friendly interface that allows a user to input all information pertaining to each of the packages 134, and automatically adds each of the packages 134, including the associated information, to the inventory 131 stored on the memory 130 of the storage warehouse/distribution center computing system 118 and/or uploaded to the remote management control center 116. It should be understood that in some embodiments the computing system 126 can be provided as one or more of the one or more devices 138.

Additionally and/or alternatively, each of the packages 134 can be provided with a label having indicia 136 thereon (see FIG. 6), e.g., a barcode, a QR code, etc., that can be scanned by the one or more devices 138 at the storage warehouse/distribution center 118 to inventory the package 134 and obtain the information pertaining thereto. For example, the indicia 136 can have all of the package's information associated therewith such that upon scanning the indicia 136 using the one or more devices 138, the scanned package 134 and all information pertaining to the scanned package 134, e.g., identification information, delivery location, dimensions (e.g., height, width, length, circumference, diameter, etc., including all dimensions of regular and irregular shapes), shape, mass/weight, center of mass/gravity, fragile designation, stacking limitations (e.g., whether other packages can be stacked on top of the package), etc., is automatically added to the inventory 131 stored on the memory 130 of the storage warehouse/distribution center computing system 118 and/or uploaded to the remote management control center 116.

The transportation and distribution system 114 can also include a package detection system 140 that is configured to automatically detect physical characteristics, e.g., information, such as, but not limited to, dimensions (e.g., height, width, length, circumference, diameter, etc., including all dimensions of regular and irregular shapes), shape, mass/weight, center of mass/gravity, etc., of a package 134, and automatically add data and information pertaining to the scanned packages 134 to the inventory 131 stored on the memory 130 of the storage warehouse/distribution center computing system 118 and/or upload the data and information to the remote management control center 116. In this regard, the package detection system 140 can include one or more optical detectors, cameras, LiDAR sensors that can generate a LiDAR point cloud (or “LiDAR images”) of the packages 134, laser distance measurers, scales, etc. The package detection system 140 can be provided at the storage warehouse/distribution center 118 or at an offsite location, e.g., a location at which a customer can drop off their package 134 for delivery.

The inventory 131, including the information pertaining to each of the packages 134, is stored on the memory 130 of the storage warehouse/distribution center computing system 118 and can be transmitted to the remote management control center 116 and/or the vehicle computing system 120, and used thereby for transportation logistics including the generation of a trailer loading plan, as discussed in greater detail below.

The remote management control center 116 can operate as a “mission control” center that manages a fleet of vehicles 100 and transportation logistics for delivering the packages 134 stored at the storage warehouse/distribution center 118, as well as packages 134 stored at other storage warehouses/distribution centers, using the fleet of vehicles 100. For example, the remote management control center 116 can receive the inventory 131 of packages 134, including the information pertaining to each of the packages 134 listed in the inventory 131, from the storage warehouse/distribution center computing system 118 (or individually for each of the packages 134 from the one or more devices 138 and/or the package detection system 140, as previously discussed). Based on the received information, as well as a database of vehicles 100, the remote management control center 116 can establish a delivery route, which can include a plurality of stops, and select a vehicle 100 to pick up and deliver the packages 134 located at the storage warehouse/distribution center 118.

Additionally, the remote management control center 116 can receive, determine, or calculate characteristics and/or requirements of the vehicle 100 and trailer 102 selected for delivery, which can be based on, for example, data stored in the associated database or characteristics of the selected vehicle 100 and trailer 102, as well as the established delivery route. The foregoing characteristics and/or requirements can include, but are not limited to, a layout of the internal volume 111 including shape and all dimensions (e.g., height, length, width, etc.), how many axles the vehicle 100 and/or the trailer 102 have, spacing between the axles of the vehicle 100 and/or the trailer 102, the wheel base of the vehicle 100 and the trailer 102, dimensions of the trailer 102, a maximum weight per axle for the vehicle 100 and/or trailer 102 (which can be based on not only the limitations of the vehicle 100 and trailer 102, but also requirements of any weigh stations along the delivery route), a maximum weight per wheel for the vehicle 100 and/or trailer 102, a maximum center of gravity height for the vehicle 100 and/or trailer 102 (which can be calculated based on the delivery route and the various turns that will be encountered by the vehicle 100 and trailer 102 during delivery), a maximum lateral offset for the center of gravity for the vehicle 100 and/or trailer 102, a maximum longitudinal offset for the center of gravity for the vehicle 100 and/or trailer 102, etc. The remote management control center 116 can transmit the foregoing information, e.g., the information pertaining to the vehicle 100 and the trailer 102 selected for delivery, the delivery route, and the determined and/or calculated characteristics and/or requirements, to the vehicle computing system 120 and the storage warehouse/distribution center computing system 126 over the network 132.

However, it should be understood that since the remote management control center 116, the vehicle computing system 120, and the storage warehouse/distribution center computing system 126 are in communication over the network 132, and/or a LAN or PAN, all data pertaining to the inventory 131 of packages 134, the selected vehicle 100 and trailer 102, and the established delivery route can be transferred therebetween, such that any of the foregoing determinations and calculations can be made by any one of the remote management control center 116, the vehicle computing system 120, and the storage warehouse/distribution center computing system 126, or such determinations and calculations can be distributed therebetween. For example, in some aspects of the present disclosure the remote management control center 116 could transfer the delivery route information to the selected vehicle 100, and the vehicle computing system 120 could determine or calculate the foregoing characteristics and/or requirements of the vehicle 100 and trailer 102 based on the delivery route received by the remote management control center 116 in combination with data stored on the memory 124 of the vehicle computing system 120 pertaining to the vehicle 100 and trailer 102. Similarly, the vehicle computing system 120 and/or the remote management control center 116 could transfer all material information to the storage warehouse/distribution center computing system 126, which could determine or calculate the foregoing characteristics and/or requirements of the vehicle 100 and trailer 102 based on the information received from the vehicle computing system 120 and the remote management control center 116.

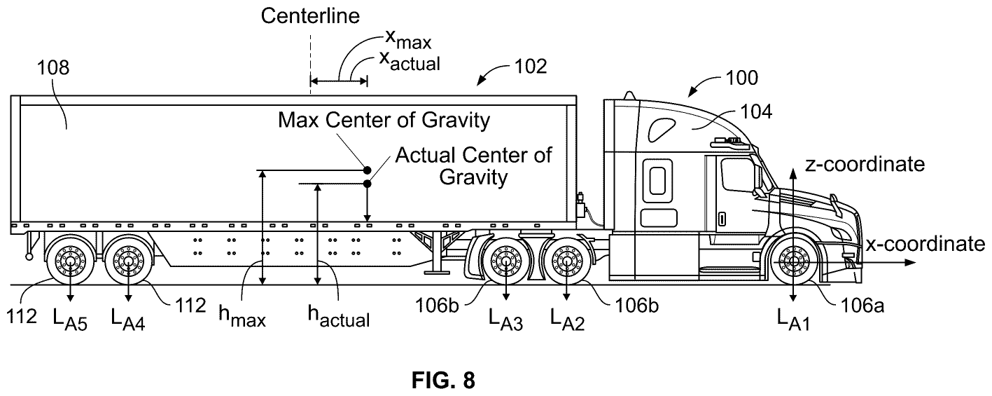

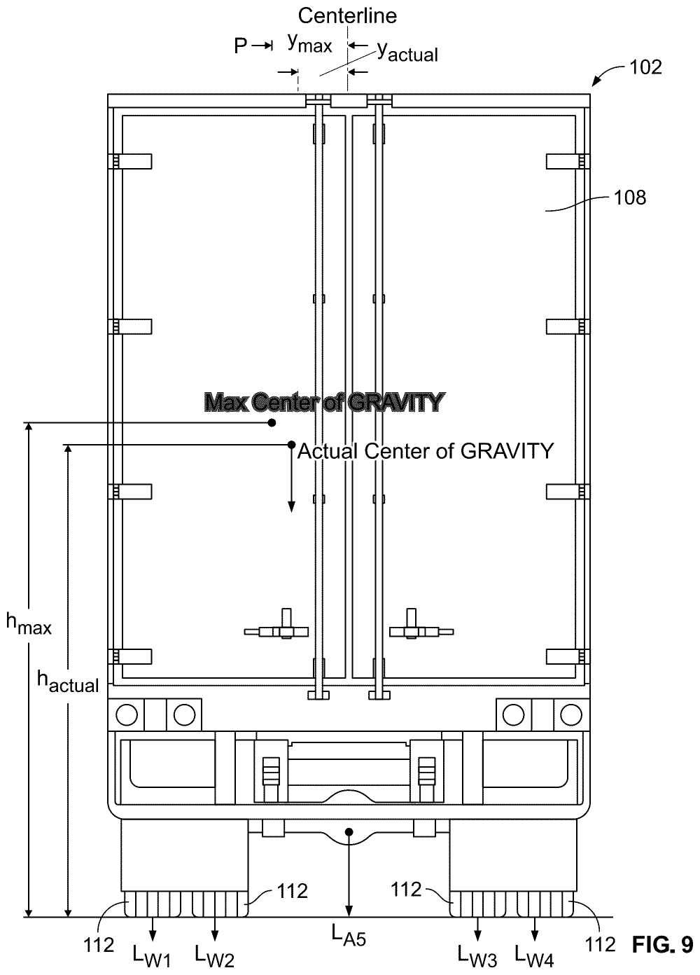

The transportation and distribution system 114 further includes a trailer loading plan generation module 142 that can be stored in the memory 130 of the storage warehouse/distribution center computing system 126, the memory 124 of the vehicle computing system 120, and/or the remote management control center 116. The trailer loading plan generation module 142 generates a loading plan for the trailer 102 that includes a position for each package 134 within the internal volume 111 of the trailer storage container 108 and an order in which the packages 134 are to be loaded. Accordingly, due to the distributed nature of the trailer loading plan generation module 142, as well as the interconnectivity and sharing of data amongst the storage warehouse/distribution center computing system 126, the vehicle computing system 120, and the remote management control center 116 of the transportation and distribution system 114, it should be understood that any one of the storage warehouse/distribution center computing system 126, the vehicle computing system 120, and the remote management control center 116 can generate the trailer loading plan using the trailer loading plan generation module 142 thereof. In this regard, the trailer loading plan generation module 142 can generate the trailer loading plan based on the foregoing information that was generated, determined, calculated, and shared by and between the storage warehouse/distribution center computing system 126, the vehicle computing system 120, and the remote management control center 116. This information includes, but is not limited to, the following:
the inventory 131 of packages 134;
the information for each of the packages 134 in the inventory 131, such as, but not limited to, identification information, delivery location, package dimensions (e.g., height, width, length, circumference, diameter, etc., including all dimensions of regular and irregular shapes), package shape, package mass/weight, center of mass/gravity for the package 134, fragile designations, stacking limitations (e.g., whether other packages 134 can be stacked on top of the package 134), etc.;
the layout, shape, and dimensions (e.g., length, width, and height) of the internal volume 111 of the storage container 108;
the delivery route, e.g., requirements of the weigh stations located on the delivery route;
a maximum weight per axle for the vehicle 100 and/or trailer 102, which can be based on not only the limitations of the vehicle 100 and trailer 102, but also any weigh stations along the delivery route;
a maximum weight per wheel 106a, 106b, 112 for the vehicle and/or trailer 102;
a maximum center of gravity height hₘₐₓ (see FIGS. 8 and 9) for the vehicle 100 and/or trailer 102, which can be calculated based on the delivery route and the various turns that will be encountered by the vehicle 100 and trailer 102 during delivery, e.g., a delivery route that has more turns or tighter turns may require a lower center of mass/gravity;
a maximum allowable center of gravity lateral offset yₘₐₓ (see FIG. 9) for the vehicle 100 and/or trailer 102;
a maximum allowable center of gravity longitudinal offset xₘₐₓ (see FIG. 8) for the vehicle 100 and/or trailer 102; and
capabilities of the vehicle 100, e.g., towing capabilities.

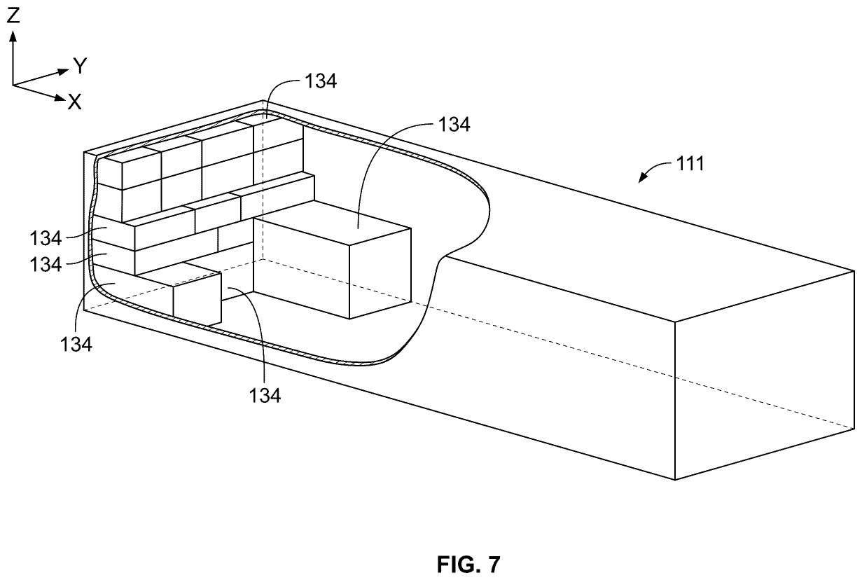

The trailer loading plan generation module 142 takes into consideration the foregoing information, calculates the most efficient and secure way to load the packages 134 onto the trailer 102, and generates a trailer loading plan based thereon that includes an optimal position and orientation within the internal volume 111 of the storage container 108 for each of the packages 134 listed in the inventory 131, or for as many of the packages 134 listed in the inventory 131 that can fit into the internal volume 111, as well as an order in which to load the packages 134. FIG. 7 is a schematic diagram of the exemplary internal volume 111 of FIG. 5 showing a plurality of packages 134 loaded therein according to a loading plan. In generating the loading plan, the trailer loading plan generation module 142 can prioritize certain aspects, while also ensuring that the resulting loading plan meets certain requirements by taking into account the safety of the cargo, the vehicle 100, and the trailer 102. In particular, the trailer loading plan generation module 142 can iteratively proceed through each potential configuration and position for each package 134 within the internal volume 111, and eliminate those configurations that do not meet the trailer loading plan requirements or do not satisfy certain requirements of the individual packages 134, e.g., the trailer loading plan generation module 142 will eliminate any configuration that results in a center of gravity that is higher than a maximum center of gravity height hₘₐₓ or requires a package 134 to be stacked on top of another package 134 having a fragile designation or stacking limitation.

In one example, the trailer loading plan generation module 142 can calculate the trailer loading plan, including an optimal way of loading the trailer 102, so as to maximize the total amount of packages 134 and ensure that the resulting fully loaded trailer 102 meets predefined safety requirements. In particular, the trailer loading plan generation module 142 can ensure that the loaded trailer 102, e.g., when loaded according to the trailer loading plan, has an actual center of gravity that is lower than a predefined threshold. That is, that the actual center of gravity has a height h_{actual} that is lower than a maximum center of gravity height hₘₐₓ, as shown in FIGS. 8 and 9, which are side and rear views, respectively, of a vehicle 100 with a loaded trailer 102 attached thereto illustrating various characteristics thereof. The actual and maximum center of gravity heights h_{actual}, hₘₐₓ can be measured with respect to the ground. As previously noted, the maximum center of gravity hₘₐₓ can be calculated by the remote management control center 116, the vehicle computing system 120, and/or the storage warehouse/distribution center computing system 126 based on characteristics of the vehicle 100, the trailer 102, the delivery route, etc. The trailer loading plan generation module 142 can calculate the actual center of gravity height h_{actual} when generating the trailer loading plan and compare the actual center of gravity height h_{actual} to the maximum center of gravity height hₘₐₓ to ensure that the actual center of gravity is not too high, and thus reduce the risk of rollover for the vehicle 100 and trailer 102. Alternatively, the trailer loading plan generation module 142 can aim to minimize the center of gravity height h_{actual} as much as possible, e.g., generate a trailer loading plan that has a center of gravity that is as low as possible, in order to minimize the risk of rollover for the vehicle 100 and trailer 102.

Accordingly, the trailer loading plan generation module 142 can generate a trailer loading plan, or select a trailer loading plan from several generated trailer loading plans, that includes as many packages 134 as possible for loading in the trailer 102 and also results in an actual center of gravity height h_{actual} that is less than a maximum center of gravity height h_{actual}. That is, the trailer loading plan generation module 142 can generate a trailer loading plan that maximizes the amount of packages while minimizing the risk of rollover for the vehicle 100 and trailer 102.

Additionally and/or alternatively, the trailer loading plan generation module 142 can ensure that the generated trailer loading plan results in a trailer 102 having an actual center of gravity that is not laterally offset y_{actual} from a centerline of the trailer 102 by more than a maximum allowable lateral offset yₘₐₓ (see FIG. 9) and/or not longitudinally offset x_{actual} from a centerline of the trailer 102 by more than a maximum allowable longitudinal offset xₘₐₓ (see FIG. 8). The maximum allowable lateral offset yₘₐₓ and the maximum allowable longitudinal offset xₘₐₓ can be calculated by the remote management control center 116, the vehicle computing system 120, and/or the storage warehouse/distribution center computing system 126 based on characteristics of the vehicle 100, the trailer 102, the delivery route, etc. The trailer loading plan generation module 142 can calculate the actual lateral offset y_{actual} and actual longitudinal offset x_{actual} of the actual center of gravity when generating the trailer loading plan and compare the actual lateral offset y_{actual} and actual longitudinal offset x_{actual} to the maximum allowable lateral offset yₘₐₓ and the maximum allowable longitudinal offset xₘₐₓ. Accordingly, the trailer loading plan generation module 142 can generate a trailer loading plan, or select a trailer loading plan from several generated trailer loading plans, that results in a center of gravity that is not laterally offset y_{actual} from a centerline of the trailer 102 by more than a maximum allowable lateral offset y ₘₐₓ (see FIG. 9) and/or not longitudinally offset x_{actual} from a centerline of the trailer 102 by more than a maximum allowable longitudinal offset xₘₐₓ (see FIG. 8), while also maximizing the amount of packages 134 being loaded in the trailer 102.

The trailer loading plan generation module 142 can also ensure that the resulting loads L_{A1}, L_{A2}, L_{A3}, L_{A4}, L_{A5} (see FIG. 8) on each axle of the vehicle 100 and the trailer 102 when the trailer 102 is loaded according to the trailer loading plan are less than maximum permitted axle loads. As previously noted, the maximum permitted axle loads can be calculated by the remote management control center 116, the vehicle computing system 120, and/or the storage warehouse/distribution center computing system 126 based on the vehicle 100, the trailer 102, the delivery route, etc. In this regard, the maximum permitted axle loads can be calculated using the Federal Bridge Gross Weight Formula. Similarly, the trailer loading plan generation module 142 can also ensure that the resulting loads L_{W1}, L_{W2}, L_{W3}, L_{W4} (see FIG. 9) on each wheel 106a, 106b, 112 of the vehicle 100 and the trailer 102 when the trailer 102 is loaded according to the trailer loading plan are less than maximum permitted wheel loads. It is noted that while FIG. 9 illustrates wheel loads for only the rear wheels 112, the foregoing is also applicable to the front wheels 106a and rear wheels 106b of the vehicle 100. The trailer loading plan generation module 142 can also consider the overall weight distribution when generating the trailer loading plan, e.g., to ensure that the weight is evenly distributed among the axles and the wheels. Accordingly, the trailer loading plan generation module 142 can generate a trailer loading plan, or select a trailer loading plan from several generated trailer loading plans, that results in axle loads L_{A1}, L_{A2}, L_{A3}, L_{A4}, L_{A5} that are less than a maximum permitted axle load and/or wheel loads L_{W1}, L_{W2}, L_{W3}, L_{W4} that are less than a maximum permitted wheel load, while also maximizing the amount of packages 134 being loaded in the trailer 102.

In another example, the trailer loading plan generation module 142 can calculate the trailer loading plan, including an optimal way of loading the trailer 102, so as to maximize the ease of retrieval of the packages 134 and ensure that the resulting fully loaded trailer 102 meets the predefined safety requirements, e.g., the safety requirements discussed herein above in connection with the maximum allowable center of gravity height hₘₐₓ, the maximum allowable lateral offset yₘₐₓ, the maximum allowable longitudinal offset xₘₐₓ, the maximum axle loads, the maximum wheel loads, etc. In particular, the trailer loading plan generation module 142 can generate a trailer loading plan that organizes the packages 134 within the trailer 102 based on the delivery route of the vehicle 100 so that those packages 134 being delivered earlier in the delivery route are positioned closer to the rear of the trailer 102, e.g., where the doors are located, while those packages 134 being delivered later in the delivery route are positioned closer to the front of the trailer 102, e.g., the portion of the trailer 102 closer to the cab 104. For example, if the vehicle 100 has five stops, the trailer loading plan generation module 142 can generate a trailer loading plan that has the packages 134 for the first stop, the second stop, the third stop, the fourth stop, and the fifth stop positioned sequentially from the rear of the trailer 102 near the doors (first stop packages 134) to the front of the trailer 102 near the cab 104 (fifth stop packages 134). Accordingly, the trailer loading plan generation module 142 can generate a trailer loading plan, or select a trailer loading plan from several generated trailer loading plans, that optimizes the positioning of packages 134 for ease of retrieval and meets the predefined safety requirements, e.g., the safety requirements discussed herein above in connection with the maximum allowable center of gravity height hₘₐₓ, the maximum allowable lateral offset yₘₐₓ, the maximum allowable longitudinal offset xₘₐₓ, the maximum axle loads, the maximum wheel loads, etc.

It should be understood that the trailer loading plan generation module 142 can take into consideration one or more of the foregoing factors, or any combination thereof, in generating the trailer loading plan. For example, the trailer loading plan generation module 142 can prioritize both maximizing the amount of packages 134 and maximizing the ease of retrieval of the packages 134, or can weigh one more heavily than the other in generating the trailer loading plan. Similarly, the trailer loading plan generation module 142 can ensure that all or less than all predefined safety requirements are satisfied by the generated trailer loading plan.

Once the trailer loading plan is generated by the trailer loading plan generation module 142, it can be transferred to one or more of the devices 138 on which it can be displayed to a user, who can follow the trailer loading plan to load the storage container 108 of the trailer 102 efficiently and safely. Alternatively, the trailer loading plan can be generated as machine readable code that includes instructions for controlling an autonomous package loader 144 and causing the autonomous package loader 144, which be located at the storage warehouse/distribution center 118, to load the storage container 108 of the trailer 102. The trailer loading plan can be provided to the autonomous package loader 144 at the storage warehouse/distribution center 118, which can in turn execute the trailer loading plan and autonomously load the packages 134 into the storage container 108 according thereto.

Additionally, once the storage container 108 is loaded, the vehicle computing system 120, the storage warehouse/distribution center computing system 126, and/or the remote management control center 116 can determine the actual total mass, the actual center of gravity, the actual axle loads, and the actual wheel loads of the vehicle 100 and loaded trailer 102, and confirm that the foregoing meet the previously discussed safety requirements, e.g., the maximum allowable center of gravity height hₘₐₓ, the maximum allowable lateral offset yₘₐₓ, the maximum allowable longitudinal offset xₘₐₓ, the maximum axle loads, the maximum wheel loads, etc. In this regard, the foregoing determinations may be made based on measurements performed at the storage warehouse/distribution center 118 while the vehicle 100 is in a parked position using multiple image sensors (or cameras) mounted or positioned at the storage warehouse/distribution center 118. Additionally, or alternatively, the foregoing determinations may be made based on measurements performed at the storage warehouse/distribution center 118 using multiple weight sensors (e.g., strain gage-based sensors) positioned at the storage warehouse/distribution center 118 to measure force or weight applied at multiple measurement points (e.g., at each wheel 106a, 106b, 112 of the vehicle 100 and the connected trailer 102).

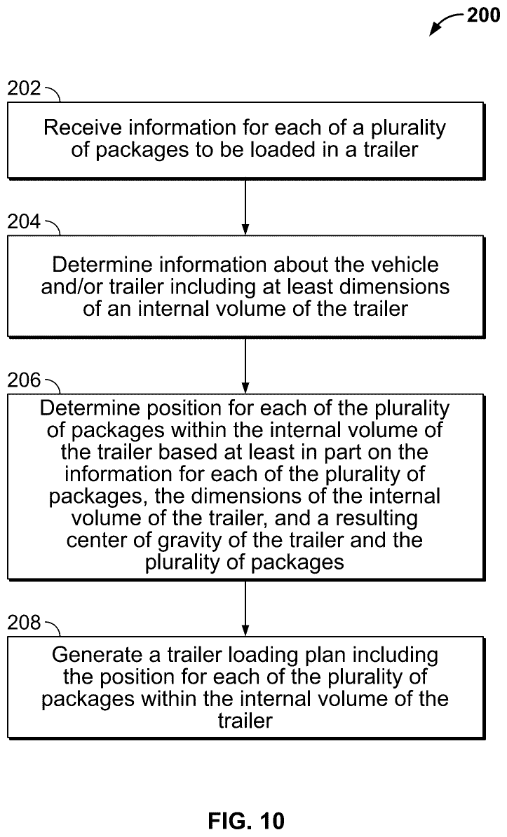

FIG. 10 is a flowchart 200 illustrating exemplary operations performed for generating a trailer loading plan according to the present disclosure. In 202, information is received for each of a plurality of packages 134 to be loaded in a trailer 102, e.g., packages 134 that are located at one or more storage warehouse/distribution centers 118 and ready for distribution/delivery. The information for each of the packages 134 can include, but is not limited to, identification information, delivery location, dimensions (e.g., height, width, length, circumference, diameter, etc., including all dimensions of regular and irregular shapes), shape, mass/weight, center of mass/gravity, fragile designation, stacking limitations (e.g., whether other packages can be stacked on top of the package), etc., or any other information disclosure herein. The information can be received by the vehicle computing system 120, the storage warehouse/distribution center computing system 126, and/or the remote management control center 116 for analysis. For example, an inventory 131 of packages 134 can be stored in the memory 130 of the storage warehouse/distribution center computing system 126, along with the information pertaining to each of the packages 134, and the inventory can be transferred from the storage warehouse/distribution center computing system 126 to the remote management control center 116 and/or the vehicle computing system 120, or between the devices 138 of the storage warehouse/distribution center 118. Alternatively, as discussed in connection with FIGS. 5 and 6, indicia 136 on each of the packages 134 can be scanned by a device 138 at the storage warehouse/distribution center 118 to obtain and inventory the information for the scanned package 134. The device 138 can transfer the information obtained from the scan to the vehicle computing system 120, the storage warehouse/distribution center computing system 126, and/or the remote management control center 116 for analysis. The information for each of the packages 118 can alternatively be received from the package detection system 140, as discussed in connection with FIG. 5. Specifically, the package detection system can automatically detect physical characteristics of the packages 134 and automatically add details and information pertaining to the scanned packages 134 to the inventory 131 stored on the memory 130 of the storage warehouse/distribution center computing system 118. The package detection system can also upload the information to the remote management control center 116 and/or the vehicle computing system 120.

In 204, information about the vehicle 100 and/or the trailer 102, e.g., trailer information, including dimensions of the internal volume 111 is determined, e.g., by the remote management control center 116, the vehicle computing system 120, or the storage warehouse/distribution center computing system 126. The information for the vehicle 100 and the trailer 102 can include, but is not limited to, a layout of the internal volume 111 including all dimensions (e.g., height, length, width, etc.), how many axles the vehicle 100 and the trailer 102 have, spacing between the axles of the vehicle 100 and the trailer 102, the wheel base of the vehicle 100 and the trailer 102, dimensions of the trailer 102, a maximum weight per axle for the vehicle 100 and trailer 102, a maximum center of gravity height for the vehicle 100 and trailer 102, a maximum lateral offset for the center of gravity for the vehicle 100 and trailer 102, a maximum longitudinal offset for the center of gravity for the vehicle 100 and trailer 102, etc., or any other information discussed herein. In some embodiments, the remote management control center 116 can determine the information about the vehicle 100 and/or the trailer 102 by accessing a database storing the information, and/or by calculating the information. For example, the remote management control center 116 can calculate the maximum center of gravity height for the vehicle 100 and trailer 102 based on information obtained from the database, as well as based on a delivery route. Alternatively, the vehicle computing system 120 can store the information pertaining to the vehicle 100 and the trailer 102 on the memory 124 thereof, and provide such information to the remote management control center 116 and/or the storage warehouse/distribution center computing system 126.

Next, in 206, a position for each of the plurality of packages 134 within the internal volume 111 is determined based at least in part on information for each of the packages 134, the dimensions of the internal volume 111, and a resulting center of gravity of the trailer 102 when loaded with the plurality of packages 134. In this regard, as previously discussed, the trailer loading plan generation module 142 can consider the information for each of the packages 134 (e.g., the package dimensions, mass/weight, center of mass/gravity, etc.), the dimensions of the internal volume 111, and the resulting center of gravity of the trailer 102 when loaded (e.g., the height h_{actual} of the center of gravity) in determining a position for each of the packages 134 within the internal volume 111. For example, the trailer loading plan generation module 142 can iteratively proceed through each potential configuration and position for each package 134, and then determine a position for each package 134 such that the resulting loaded trailer 102 meets certain safety requirements. As previously discussed, the safety requirements can include, but are not limited to, a maximum allowable center of gravity height h ₘₐₓ, a maximum allowable lateral offset yₘₐₓ, a maximum allowable longitudinal offset xₘₐₓ, maximum axle loads, maximum wheel loads, etc. The trailer loading plan generation module 142 can also determine a position for each package 134 by prioritizing certain factors, such as maximizing the amount of packages 134 and maximizing the ease of retrieval of the packages 134, as previously discussed.

In 208, the trailer loading plan generation module 142 generates a trailer loading plan that includes a position for each of the plurality of packages 134 within the internal volume 111 of the trailer 102. The trailer loading plan can also include, in addition to a position for each of the plurality of packages 134 within the internal volume 111, an order in which to load the trailer 102. The trailer loading plan can be transferred to one or more of the devices 138 on which it can be displayed to a user, who can follow the trailer loading plan to load the storage container 108 of the trailer 102 efficiently and safely. Alternatively, the trailer loading plan can be provided as machine readable code that includes instructions for controlling an autonomous package loader 144 and causing the autonomous package loader 144 to load the storage container 108 of the trailer 102. In such instances, the trailer loading plan can be provided to the autonomous package loader 144 at the storage warehouse/distribution center 118, which can in turn execute the trailer loading plan and autonomously load the packages 134 into the storage container 108 according thereto.

The foregoing systems and methods allow for the generation of a trailer loading plan that not only accounts for an optimal localization of the center of gravity/mass of the trailer 102 that meets certain safety requirements and minimizes the risk of rollover, but also prioritizes certain factors, such as maximizing the amount of packages and maximizing the ease of retrieval of the packages.

Some embodiments involve one or more operations and/or processes that are described herein as being performed automatically, e.g., without requiring operator input or instruction. It should be understood that, in some embodiments, such operations and processes could be performed manually or with some level of operator input or instruction without departing from the spirit or scope of the present disclosure.

Some embodiments involve the use of one or more electronic processing or computing devices. As used herein, the terms “processor” and “computer” and related terms, e.g., “processing device,” “computing device,” and “computing system,” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm operations described above may be implemented as electronic hardware, software, or combinations of both. Certain disclosed components, blocks, modules, circuits, and operations are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or operation recited in the singular and proceeded with the word “a” or “an” should be understood as not excluding plural elements or operations unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or operations of the methods may be utilized independently and separately from other described components or operations.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed herein above, are intended to be included within the scope of the disclosure.

What is claimed is:

1. A method of generating a trailer loading plan, comprising:
receiving information for each of a plurality of packages, the information including at least dimensions of each package and a mass of each package;
determining trailer information including at least dimensions of an internal volume of a trailer;
determining a position for each of the plurality of packages within the internal volume of the trailer based at least in part on the information for each of the plurality of packages, the dimensions of the internal volume of the trailer, and a resulting center of gravity of the trailer and the plurality of packages; and
generating a trailer loading plan including the position for each of the plurality of packages within the internal volume of the trailer.

2. The method of claim 1, wherein determining a position for each of the plurality of packages includes:
comparing a height of the resulting center of gravity of the trailer and the plurality of packages to a maximum center of gravity height; and
confirming that the height of the resulting center of gravity of the trailer and the plurality of packages is less than the maximum center of gravity height prior to generating the trailer loading plan.

3. The method of claim 2, wherein the maximum center of gravity height is based on a travel route for the trailer.

4. The method of claim 1, wherein determining a position for each of the plurality of packages includes:
minimizing a height of the resulting center of gravity of the trailer and the plurality of packages.

5. The method of claim 1, wherein the trailer information includes a maximum weight per axle, and the maximum weight per axle is considered in determining the position for each of the plurality of packages within the internal volume of the trailer.

6. The method of claim 1, wherein the position for each of the plurality of packages is determined so as to maximize the amount of packages positioned within the internal volume of the trailer.

7. The method of claim 1, wherein receiving information for each of the plurality of packages includes:
scanning indicia associated with each of the plurality of packages;
inputting the information for each of the plurality of packages using a user device; and/or detecting the information for each of the plurality of packages using a detection system.

8. The method of claim 1, comprising:
receiving a list of the plurality of packages to be loaded in the trailer.

9. The method of claim 8, wherein the list includes the information for each of the plurality of packages.

10. The method of claim 1, wherein the information for each of the plurality of packages includes a delivery location for the respective package, and the position for each of the plurality of packages within the internal volume of the trailer is determined based at least in part on the delivery location for the respective package.

11. A system for generating a trailer loading plan, comprising:
a memory; and
a processor in communication with the memory, the processor:
receiving information for each of a plurality of packages, the information including at least dimensions of each package and a mass of each package;
determining trailer information including at least dimensions of an internal volume of the trailer;
determining a position for each of the plurality of packages within the internal volume of the trailer based at least in part on the information for each of the plurality of packages, the dimensions of the internal volume of the trailer, and a resulting center of gravity of the trailer and the plurality of packages; and
generating a trailer loading plan including the position for each of the plurality of packages within the internal volume of the trailer.

12. The system of claim 11, wherein the processor, when determining a position for each of the plurality of packages within the internal volume of the trailer, compares a height of the resulting center of gravity of the trailer and the plurality of packages to a maximum center of gravity height and confirms that the height of the resulting center of gravity of the trailer and the plurality of packages is less than the maximum center of gravity height prior to generating the trailer loading plan.

13. The system of claim 12, wherein the maximum center of gravity height is based on a travel route for the trailer.

14. The system of claim 11, wherein the processor, when determining a position for each of the plurality of packages within the internal volume of the trailer, minimizes a height of the resulting center of gravity of the trailer and the plurality of packages.

15. The system of claim 11, wherein the trailer information includes a maximum weight per axle, and the processor considers the maximum weight per axle when determining the position for each of the plurality of packages within the internal volume of the trailer.

16. The system of claim 11, wherein the processor determines the position for each of the plurality of packages within the internal volume of the trailer so as to maximize the amount of packages positioned within the internal volume of the trailer.

17. The system of claim 11, wherein the processor receives the information for each of the plurality of packages from:
a scanning device configured to scan indicia associated with each of the plurality of packages, the scanning device and/or the processor obtaining the information based on the indicia;
a user input device configured to receive the information for each of the plurality of packages as an input by a user; and/or
a detection system configured to detect the information for each of the plurality of packages.

18. The system of claim 11, wherein the processor receives a list of the plurality of packages to be loaded in the trailer.

19. The system of claim 18, wherein the list includes the information for each of the plurality of packages.

20. The system of claim 11, wherein the information for each of the plurality of packages includes a delivery location for the respective package, and the position for each of the plurality of packages within the internal volume of the trailer is determined by the processor based at least in part on the respective delivery location.
